(19) United States
(12) Patent Application Publication
(10) Pub. No.: US 2026/0216636 A1
(43) Pub. Date: Jul. 30, 2026

(54) CARBON DIOXIDE RECOVERY AND CONDITIONING SYSTEM AND METHOD FOR AMMONIA-BASED CARBON DIOXIDE CAPTURE PROCESSES

(71) Applicant: NUOVO PIGNONE TECNOLOGIE - S.R.L., Florence (IT)

(72) Inventor: Michael BALFE, Frankfurt, Hesse (DE)

(21) Appl. No.: 19/149,180

(22) PCT Filed: Jan. 19, 2024
(86) PCT No.: PCT/EP2024/025033

§ 371 Date: Jul. 18, 2025

(30) Foreign Application Priority Data
Jan. 19, 2023 (IT) 102023000000771

(51) Int. Cl. B01D 53/14

(52) U.S. Cl. CPC B01D 53/1475; B01D 53/1425; B01D 2252/102; B01D 2257/504

(57) ABSTRACT

The carbon dioxide recovery and conditioning system for an ammonia-based carbon dioxide capture process, wherein the system comprises a regenerator column, and a regenerator cooling system adapted to cool a gaseous flow comprising carbon dioxide, ammonia and moisture, which collects at the top of the regenerator column. A carbon dioxide chilling and drying arrangement is fluidly coupled to the regenerator cooling system and to a carbon dioxide recovery line. The system effectively removes moisture and ammonia upstream of the dryer. Disclosed herein is also a method for carbon dioxide recovery and conditioning.

### TECHNICAL FIELD

The present disclosure concerns carbon dioxide capturing systems. Specifically, embodiments disclosed herein concern improvements to carbon dioxide recovery and conditioning systems and methods adapted to remove carbon dioxide from an ammonia-containing solution loaded with carbon dioxide.

### BACKGROUND ART

Carbon dioxide (CO₂) is a greenhouse gas which is believed to be one of the major contributors to global warming and climate changes. Carbon dioxide is generated by several industrial processes, where thermal power is generated by combustion of fossil fuels, such as natural gas and oil.

Carbon capture and storage (in short CCS) is a technology effective to make deep cuts in greenhouse gas emissions. Post combustion capture (in short PCC) is a process which uses an aqueous absorption solution containing compounds such as ammonia to capture carbon dioxide from flue gas generated by combustion of fossil fuel

The ammonia-containing solution contacts carbon dioxide-rich flue gas in an absorber and causes carbon dioxide to remain trapped in the solution. Carbon dioxide-loaded absorption solution (CO₂-rich absorption solution) is then transferred to a regenerator, where carbon dioxide is removed and delivered to a carbon dioxide recovery line for further processing, while the carbon dioxide-lean solution obtained by removing carbon dioxide therefrom is recirculated towards the absorber.

Regenerating the aqueous solution containing ammonia and conditioning the recovered carbon dioxide, in particular to remove ammonia which slips from the regenerator is a complex and expensive process.

Improvements in the carbon dioxide recovery and conditioning process to make such process more efficient and effective, reducing the costs of the system and the energy required to run it would be welcomed in the art.

It is therefore an aim of the subject matter disclosed herein to ameliorate the carbon dioxide recovery and conditioning process downstream of a regenerator for a post combustion capture using ammonia-based aqueous solutions.

### SUMMARY

According to one aspect, disclosed herein is a carbon dioxide recovery and conditioning system for an ammonia-based carbon dioxide capture process. The system comprises a regenerator column and a regenerator cooling system adapted to cool a gaseous flow comprising carbon dioxide, ammonia and moisture, which collects at the top of the regenerator column. Furthermore, a carbon dioxide chilling and drying arrangement is fluidly coupled to the regenerator cooling system and to a carbon dioxide recovery line.

In embodiments disclosed herein, the carbon dioxide chilling and drying arrangement comprises a first carbon dioxide chiller adapted to be fluidly coupled to an outlet of the regenerator cooling system. The carbon dioxide chilling and drying arrangement further comprises a first carbon dioxide dryer fluidly coupled to an outlet of the first carbon dioxide chiller. A second carbon dioxide chiller is adapted to be fluidly coupled to the outlet of the regenerator cooling system. A second carbon dioxide dryer is fluidly coupled to an outlet of the second carbon dioxide chiller. The first carbon dioxide dryer and the second carbon dioxide dryer are fluidly coupled to a carbon dioxide recovery line. A dryer and chiller regenerative arrangement is adapted to regenerate selectively one of said first carbon dioxide dryer and second carbon dioxide dryer and one of said first carbon dioxide chiller and second carbon dioxide chiller while the other of said first carbon dioxide dryer and second carbon dioxide dryer and the other of said first carbon dioxide chiller and second carbon dioxide chiller are operating.

The dryer and chiller regenerative arrangement comprises a fluid coupling between the first carbon dioxide chiller and the regenerator cooling system, and between the second carbon dioxide chiller and the regenerator cooling system, adapted to return a flow of regenerating carbon dioxide from the carbon dioxide chiller being regenerated to the regenerator cooling system.

Further features and embodiments of the carbon dioxide recovery and conditioning system of the present disclosure are described in detail below, reference being made to the enclosed drawings, and are set out in the appended claims.

According to a further aspect, disclosed herein is a method for recovering and conditioning carbon dioxide from an ammonia-containing solvent. The method comprises:
processing a CO₂-rich absorption solution in a regenerator column and collecting a gaseous flow containing carbon dioxide, ammonia and moisture therefrom;
reducing the temperature of the gaseous flow and removing moisture and ammonia therefrom in a regenerator cooling system;
further chilling the gaseous flow in a carbon dioxide chiller and removing further moisture and ammonia therefrom in a carbon dioxide chiller;
drying the gaseous flow in a carbon dioxide dryer; and
collecting dry carbon dioxide downstream of the carbon dioxide dryer.

Further features and embodiments of the method are described below and st out in the appended claims.

### BRIEF DESCRIPTION OF THE DRAWINGS

Reference is now made briefly to the accompanying drawings, in which:

FIG. 1 is a schematic of a regenerator system including a carbon dioxide recovery and conditioning system according to the present disclosure in one embodiment;

FIG. 2 is the same schematic of FIG. 2 in a different operating condition;

FIG. 3 is a schematic of a regenerator system including a carbon dioxide recovery and conditioning system according to the present disclosure in a further embodiment; and

FIG. 4 is a flowchart summarizing a method of carbon dioxide recovering and conditioning according to the present disclosure.

### DETAILED DESCRIPTION

The system comprises a regenerator tower or column, which receives a flow of CO₂-rich absorption solution from an absorber. The absorption solution is treated in the regenerator column to remove carbon dioxide therefrom and obtain a CO₂-lean absorption solution which is returns to the absorber. The gaseous carbon dioxide flow exiting at the top of the regenerator column is treated for removing ammonia slipping from the regenerator column and for further removing moisture. Low moisture and very low ammonia contents in the carbon dioxide flow are achieved by chilling the gaseous flow in a carbon dioxide chiller prior to passing it through a carbon dioxide dryer, for instance comprising a molecular sieve or desiccant. The molecular sieve or desiccant is thus exposed to a reduced moisture load and is protected against contact with ammonia. A dryer of smaller dimensions, compared to the dryers of the prior art can be used. A regeneration arrangement is provided to regenerate the carbon dioxide dryer and the carbon dioxide chiller. Additional advantageous features of the system and of a carbon dioxide conditioning method are described below with reference to exemplary embodiments illustrated in the attached drawings.

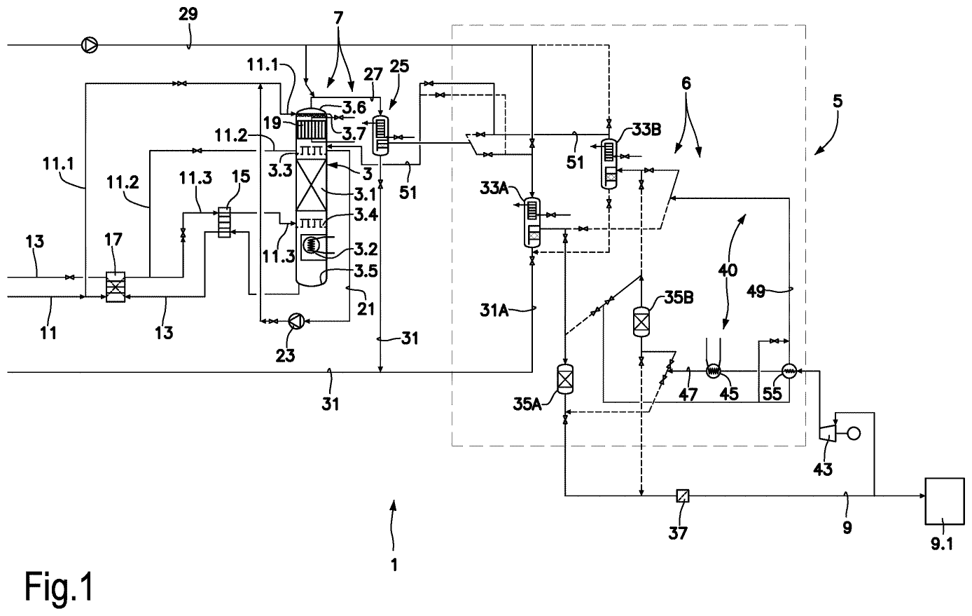

Turning now to the drawings, a first schematic of a system according to the present disclosure is shown in FIG. 1

According to the embodiment of FIG. 1, a carbon dioxide recovery and conditioning system 1 includes a regenerator column 3 and a carbon dioxide conditioning section 5 which in turn includes a carbon dioxide chilling and drying arrangement 6 fluidly coupled to a regenerator cooling system 7 and to a carbon dioxide recovery line 9.

The regenerator column 3 is adapted to receive a CO₂-rich absorption solution from a rich absorption solution inlet line 11, which can be fluidly coupled to an absorber (not shown) in a carbon capture section. The carbon capture section can be based on a chilled ammonia process (CAP), mixed-salt process (MSP), processes using ammonia mixed into an amine mixture, or any other process using a water solution containing ammonia to capture carbon dioxide from a flue gas and releasing carbon dioxide in the regenerator column 3.

After carbon dioxide has been removed from the aqueous solution, a CO₂-lean absorption solution is returned through a lean solution outlet line 13 to the absorber.

In embodiments, the rich absorption solution inlet line 11 is split into a plurality of liquid feeds (three in the embodiment illustrated in FIG. 1), labeled 11.1, 11.2 and 11.3 which deliver the CO₂-rich absorption solution in three different positions inside the regenerator column 3. The first, uppermost liquid feed, or inlet duct, 11.1 can be fluidly coupled to the top of the regenerator column 3 above a regenerator overhead condenser, to be described, the second, intermediate liquid feed, or inlet duct, 11.2 can be fluidly coupled in the upper region of the regenerator column 3 upstream the regenerator overhead condenser, for instance above the regenerator mass transfer internals or packing 3.1, and the third, lower liquid feed, or inlet duct, 11.3 can be fluidly coupled to the regenerator column 3 in a position under the regenerator packing 3.1.

The regeneration process is an endothermic process requiring thermal power delivered to the regenerator column 3. In the embodiment of FIG. 1 thermal power is delivered to the regenerator column 3 through a regenerator reboiler 3.2, positioned in the lower part of the regenerator column 3, under the regenerator packing 3.1 and under the lower liquid feed 11.3.

In the embodiment of FIG. 1, the regenerator column 3 further includes an upper liquid distribution tray 3.3 arranged above the regenerator packing 3.1 and a lower liquid distribution tray 3.4 arranged below the regenerator packing 3.1. Lean absorption solution collects at the bottom 3.5 of the regenerator column 3 and is removed through the lean solution outlet line 13.

Since the lean solution has a temperature higher than the CO₂-rich absorption solution flowing through the rich solution inlet line 11, recovery heat exchangers can be provided, to remove heat from the lean solution and pre-heat the CO₂-rich absorption solution before feeding the CO₂-rich absorption solution in the regenerator column 3. In the embodiment of FIG. 1 a high-temperature heat exchanger 15 and a low-temperature heat exchanger 17 are provided for this purpose. Hot lean solution from the bottom of the regenerator column 3 flows through a hot side of each heat exchanger 15, 17 to warm up the CO₂-rich absorption solution entering the regenerator column 3. A first side stream of CO₂-rich absorption solution is diverted from the rich solution inlet line 11 and fed to an overhead condenser 19, described in more detail below, specifically on top of the overhead condenser 19. In some embodiments, the side stream of CO₂-rich absorption solution delivered to the overhead condenser 19 is diverted through the first, upper, liquid feed 11.1 upstream of both heat exchangers 15, 17, and delivered to the top of the regenerator column 3. A second side stream of CO₂-rich absorption solution is diverted through the second, intermediate liquid feed 11.2 such that warmer CO₂-rich absorption solution is fed on top of the regenerator packing 3.1. The remaining CO₂-rich absorption solution flows in the regenerator column 3 through the third, lower liquid feed 11.3 at the highest temperature, due to heat exchange in both high-temperature exchanger 15 and low-temperature heat exchanger 17.

Carbon dioxide in gaseous form separates from the solution in the regenerator column 3 and flows upwards toward the top 3.6 of the regenerator column 3, wherefrom a gaseous stream consisting mainly of carbon dioxide, moisture and ammonia (herein after also referred to as CO₂-containing gaseous flow or CO₂-containing gaseous stream) exits from the top of the regenerator column 3.

In the embodiment of FIG. 1 the regenerator cooling system 7 includes an overhead condenser 19, which can be located inside the regenerator column 3, in the upper portion thereof, as shown in FIG. 1. In other embodiments, the overhead condenser 19 can be arranged outside the regenerator column 3.

A heat-recovery cooling medium flows in the cold side of the overhead condenser 19 in heat exchange with the CO₂-containing gaseous stream flowing in the downwards to upwards direction inside the regenerator column 3 and through the hot side of the overhead condenser 19. Moisture and ammonia condense on the surfaces of the overhead condenser 19 and are collected on the upper liquid distribution tray 3.3 and provided to the regenerator packing 3.1 along with the liquid feed 11.2.

The heat-recovery cooling medium flowing through the cold side of the overhead condenser 19 recovers heat from the CO₂-containing gaseous stream. Heat can be recovered at a usefully high temperature, for instance around 70-90° C. In some embodiments the CO₂-containing gaseous stream entering the overhead condenser 19 may be at a temperature around 120° C. and the CO₂-containing gaseous stream exiting the overhead condenser 19 at the top thereof may be at a temperature around 80° C.

Cooling of the CO₂-containing gaseous stream causes condensation of moisture and ammonia contained therein. The liquid collecting at the bottom of the overhead condenser 19 in the liquid distribution tray 3.3 has a high affinity for ammonia and reduces moisture and ammonia content of the CO₂-containing gaseous stream.

According to some embodiments, the regeneration column 3 comprises a recycling line adapted to recycle a portion of liquid collecting at the bottom of the regenerator overhead condenser 19 to the top of the regenerator overhead condenser 19. In FIG. 1 the recycling line is shown at 21 and includes a recycling pump 23. In this embodiment, the recycling line 21 merges into the first liquid feed 11.1. The CO₂-rich absorption solution from the first liquid feed 11.1, which also contains the recycled liquid pumped through the recycling line 21, is sprayed on top of the overhead condenser 19 through a nozzle arrangement 3.7.

In other embodiments, the recycling line 21 can be omitted and CO₂-rich absorption solution from the liquid feed 11.1 only is sprayed through nozzles 3.7 on top of the overhead condenser 19. Using a recycling line 21 may be advantageous to reduce the amount of cold CO₂-rich absorption solution delivered through liquid feed 11.1 and may reduce re-absorption of carbon dioxide and improve thermal system efficiency.

In both cases, liquid sprayed on top of the overhead condenser 19 prevents precipitations of ammonia salts, especially in start-up conditions and transients.

The top 3.6 of the regenerator column 3 is fluidly coupled to a carbon dioxide cooler 25 through a line 27. CO₂-containing stream which has been cooled in the overhead condenser 19, and wherefrom a portion of the moisture and ammonia contained therein has been removed, is thus delivered to the carbon dioxide cooler 25 for further cooling and moisture and ammonia removal.

The CO₂-containing gaseous stream is further cooled down, e.g. from around 80° C. to around ambient temperature by heat rejection in the carbon dioxide cooler 25. The heat removed from the CO₂-containing gaseous stream in the carbon dioxide cooler 25 can be rejected in the environment or recovered, if this is convenient.

In some embodiments, a wash water line 29 can be provided, to add water on top of the carbon dioxide cooler 25, namely in the vicinity of the vapor inlet thereof. Water addition in the carbon dioxide cooler 25 can lead to a further reduction of ammonia in the gaseous stream, as the ammonia is absorbed by wash water delivered through wash water line 29. The wash water fed to the carbon dioxide cooler 25 can remove ammonia salts which may form on the metal surfaces of the carbon dioxide cooler 25 to prevent or limit fouling thereof. Ammonia loaded wash water can be removed from the carbon dioxide cooler 25 through a loaded wash water discharge line 31.

The carbon dioxide cooler 25 removes condensed liquid and any suspended ammonia salts form the CO₂-containing gaseous stream which is further processed in the carbon dioxide chilling and drying arrangement 6, whereto the CO₂-containing gaseous stream is fed from the carbon dioxide cooler 25. The carbon dioxide chilling and drying arrangement 6 has the purpose of further removing moisture and ammonia from the CO₂-containing gaseous stream. The resulting flow exiting the carbon dioxide chilling and drying arrangement consists almost exclusively of carbon dioxide with low amount of moisture and very low amounts of ammonia, typically below 10 mole ppm moisture and below 1 mole ppb NH3, which is collected in the carbon dioxide recovery line 9.

In general terms, the carbon dioxide chilling and drying arrangement 6 has a dual configuration, including a first carbon dioxide chiller fluidly coupled in series with a first carbon dioxide dryer, and a second carbon dioxide chiller fluidly coupled in series with a second carbon dioxide dryer. In use, one of the first carbon dioxide chiller and second carbon dioxide chiller chills the CO₂-containing gaseous stream, while the other carbon dioxide chiller is in a regenerative phase. Similarly, the corresponding one of said first carbon dioxide dryer and second carbon dioxide dryer is in use, while the other carbon dioxide dryer is in a regenerative phase to remove moisture collected therein.

Turning now to FIG. 1, the carbon dioxide chilling and drying arrangement 6 comprises a first carbon dioxide chiller 33A and a second carbon dioxide chiller 33B. In use, the carbon dioxide chiller 33A or 33B can be adapted to reduce the temperature of the CO₂-containing gaseous stream down to between 0° C. and 10° C., for instance, typically around 5° C. at a pressure of, e.g., 15-21 barA. It shall be understood that the values mentioned above are by way of example and should not be construed as limiting the scope of the present disclosure.

Under these operating conditions, moisture contained in the CO₂-containing gaseous stream condenses with ammonia or may precipitate or anti-sublimate forming ammonia salts, in particular ammonia bicarbonate.

Each carbon dioxide chiller 33A, 33B can include a demister, which removes liquid or solid particles from the CO₂-containing gaseous stream which flows from the respective carbon dioxide chiller 33A, 33B towards the carbon dioxide dryer, described below. Each carbon dioxide chiller 33A, 33B can be fluidly coupled (through line 31A), to the wash water discharge line 31. Moreover, each carbon dioxide chiller 33A, 33B can be fed with wash water through wash water line 29. Wash water can be fed in each carbon dioxide chiller 33A, 33B in the vicinity of the respective vapor inlet thereof.

Each carbon dioxide chiller 33A, 33B can include a cold side wherein a refrigerant circulates.

In the embodiment described so far, the carbon dioxide exiting at a temperature of around 80° C. is chilled down to a temperature around 5° C., for instance, in a two-step chilling process, which is performed partly in the carbon dioxide cooler 25 and partly in either one or the other of said first carbon dioxide chiller 33A and second carbon dioxide chiller 33B. Different cooling/chilling fluids are used by way of example, e.g., water in the carbon dioxide cooler 25 and a refrigerant in the first and second carbon dioxide chillers 33A, 33B.

In other embodiments the carbon dioxide cooler 25 can be omitted or can be incorporated in each of the first carbon dioxide chiller 33A and second carbon dioxide chiller 33B.

The first carbon dioxide chiller 33A is fluidly coupled to a first carbon dioxide dryer 35A. In the same way, the second carbon dioxide chiller 33B is fluidly coupled to a second carbon dioxide dryer 35B.

In some embodiments, each carbon dioxide dryer 35A, 35B can comprise a molecular sieve or alternatively a desiccant bed, through which the CO₂-containing gaseous stream flows for removal of the remaining moisture content therefrom.

By providing a carbon dioxide chiller upstream of each carbon dioxide dryer, the ammonia content in the CO₂-containing gaseous stream is reduced to some ppb (parts-per-billion), such that the desiccant bed or the molecular sieve in the carbon dioxide dryer 35A, 35B is protected from damages that may be caused by a higher content of ammonia in the gaseous flow streaming through the dryer.

The drastic reduction of moisture and ammonia content in the CO₂-containing gaseous stream flowing through the dryers 35A, 35B allows reducing the dimension of the dryers and therefore the desiccant material contained therein. A protective guard bed, adapted to further remove ammonia from the gaseous flow, as usually provided in the dryers of the current art can be dispensed with, since the residual ammonia content in the gaseous flow delivered from the carbon dioxide chillers 33A, 33B is typically below 1 ppb.

The gaseous flow exiting the carbon dioxide dryers 35A, 35B finally consists almost exclusively of carbon dioxide, with potentially no ammonia (below 1 ppb, for instance) and substantially dry, with a moisture content which can range between 1 and 10 ppm for instance, depending on desired CO₂ moisture specifications.

A filter 37 can be provided in the carbon dioxide recovery line 9 downstream of the carbon dioxide dryers 35A, 35B to remove dust which may be entrained in the carbon dioxide flow.

As mentioned above, the first carbon dioxide chiller 33A and the first carbon dioxide dryer 35A on one side and the second carbon dioxide chiller 33B and the second carbon dioxide dryer 35B operate alternatively, i.e, are in service alternatively, while the others are in a regenerative phase. In the operating conditions of FIG. 1, solid lines illustrate active fluid connections while dashed lines illustrate inoperative (closed) fluid connections. In the operating condition shown in FIG. 1, the fluid connection between the first carbon dioxide chiller 33A and the first carbon dioxide dryer 35A is open (shown in solid line), and a fluid connection between the carbon dioxide cooler 25 and the first carbon dioxide chiller 33A is also open. The CO₂-containing gaseous stream can therefore flow from the carbon dioxide cooler 25 through the first carbon dioxide chiller 35A and therefrom through the first carbon dioxide dryer 35A, reaching the carbon dioxide recovery line 9.

Conversely, no CO₂-containing gaseous stream can flow from the carbon dioxide cooler 25 towards the second carbon dioxide chiller 33B and the second carbon dioxide dryer 35B, since the respective fluid connection is closed (which is pictorially represented by dashed lines). Respective opening and closing valves are foreseen for this purpose.

In use, residual moisture in the CO₂-containing gaseous stream reaching the respective carbon dioxide dryers 35A, 35B accumulates in the molecular sieves contained therein. This requires periodic regeneration of the carbon dioxide dryers to remove moisture accumulated therein.

For this purpose, the system of FIG. 1 includes a dryer and chiller regenerative arrangement 40, which uses a fraction of the dry carbon dioxide from the carbon dioxide recovery line 9 to regenerate the carbon dioxide dryer 35A, 35B which is temporarily not in service. In the operative conditions of FIG. 1, while the first carbon dioxide dryer 35A is in service, the second carbon dioxide dryer 35B is in a regenerative phase. This is pictorially represented by solid lines connecting the second carbon dioxide dryer 35B to a carbon dioxide compressor 43 forming part of the dryer and chiller regenerative arrangement 40.

The dryer and chiller regenerative arrangement 40 further includes a heater 45, for instance an electric heater, positioned downstream of the carbon dioxide compressor 43 in a regeneration line 47 which fluidly connects the carbon dioxide compressor 43 to the carbon dioxide dryer which is temporarily in a regenerative phase. In the operating conditions of FIG. 1 the regeneration line 47 is fluidly coupled to the second carbon dioxide dryer 35B, such that compressed and heated dry carbon dioxide streams through the second carbon dioxide dryer 35B to remove moisture therefrom. The dryer and chiller regenerative arrangement 40 further includes a fluid connection 49 between the carbon dioxide dryer which is temporarily being regenerated and the respective carbon dioxide chiller, in the operating condition of FIG. 1 the second carbon dioxide chiller 33B.

Therefore, the regenerating carbon dioxide delivered by the carbon dioxide compressor 43 through the second carbon dioxide dryer 35B flows from the second carbon dioxide dryer 35B through the second carbon dioxide chiller 33B. The carbon dioxide chiller which is temporarily in the regenerative phase, i.e., the second carbon dioxide chiller 33B in the operating condition of FIG. 1, is fluidly coupled to the regenerative column 3 through a return line 51. In the embodiment of FIG. 1 the return line 51 connects the carbon dioxide chiller being regenerated to the upper portion of the regenerative column 3, above the regenerator packing 3.1 upstream the overhead condenser 19. The regenerating carbon dioxide flowing through the carbon dioxide chiller 35B removes condensate, moisture, and possible ammonia salt deposits therefrom through vaporization and sublimation and recycles the moisture and the ammonia towards the regenerative column 3.

In the embodiment of FIG. 1, a heat recovery exchanger 55 recovers heat from the carbon dioxide flow discharged by the second carbon dioxide dryer 35B to preheat the regenerating carbon dioxide delivered by the carbon dioxide compressor 43. The amount of power (typically electric power) supplied to the heater 45 can thus be reduced.

Summarizing, in the operating condition of FIG. 1, the CO₂-containing gaseous stream flowing in the downward-upward direction in the regenerator column 3 is cooled in the overhead condenser 19 and further cooled and chilled in the carbon dioxide cooler 25 and in the first carbon dioxide chiller 33A to remove moisture and ammonia therefrom. The almost ammonia-free CO₂-containing gaseous stream is further dried in the first dryer 35A and collected in the carbon dioxide recovery line 9. While the above-mentioned branch of the carbon dioxide conditioning section 5 is in service, the second carbon dioxide dryer 35B and the second carbon dioxide chiller 33B are regenerated by a small flow (about 2-5% of the total carbon dioxide flow in the carbon dioxide recovery line 9) of carbon dioxide streaming in counterflow sequentially in the second carbon dioxide dryer 35B and in the second carbon dioxide chiller 33B.

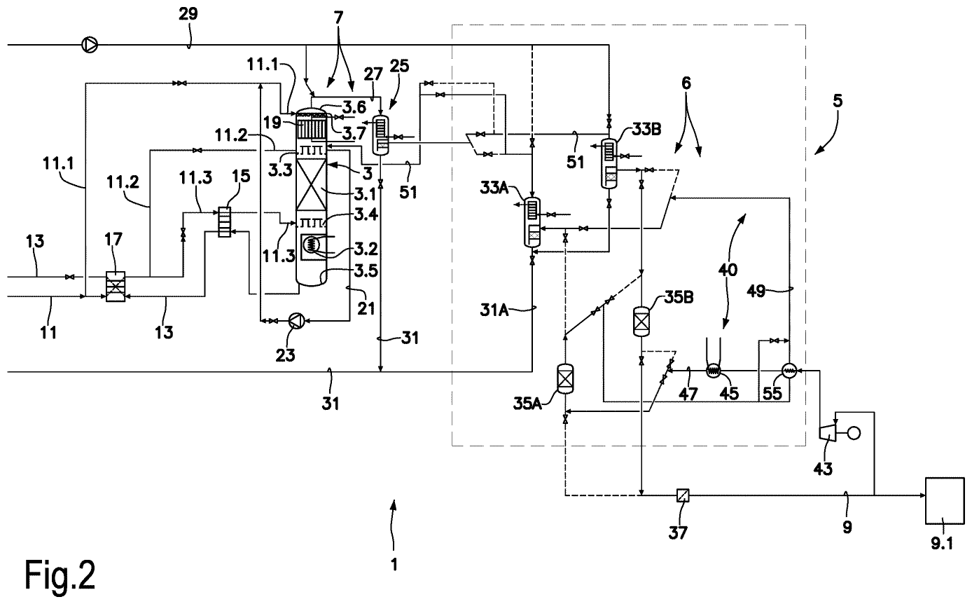

When regeneration of the second carbon dioxide dryer 35B and the second carbon dioxide chiller 33B is completed and the first carbon dioxide dryer 35B needs regeneration, the system is switched in the operating condition of FIG. 2. The closed fluid lines are shown in dashed lines and the open (operative) lines are shown in solid lines. In this operating condition, the second carbon dioxide chiller 33B and the second carbon dioxide dryer 35B are in service, while the first carbon dioxide dryer 35A and the first carbon dioxide chiller 33A are in the regeneration phase. Dry and ammonia-free carbon dioxide is compressed by the carbon dioxide compressor 43, heated by heater 45 and streams in counterflow through the first carbon dioxide dryer 35A and the first carbon dioxide chiller 33A and is finally delivered to the regenerator column 3 through line 51.

In general, switching from one carbon dioxide chiller and respective carbon dioxide dryer to the other is performed when the time required to saturate with moisture the molecular sieve or desiccant of the carbon dioxide dryer which is temporarily in service is lapsed. Within the same interval full regeneration of the carbon dioxide dryer which is temporarily in the regeneration phase is achieved by design.

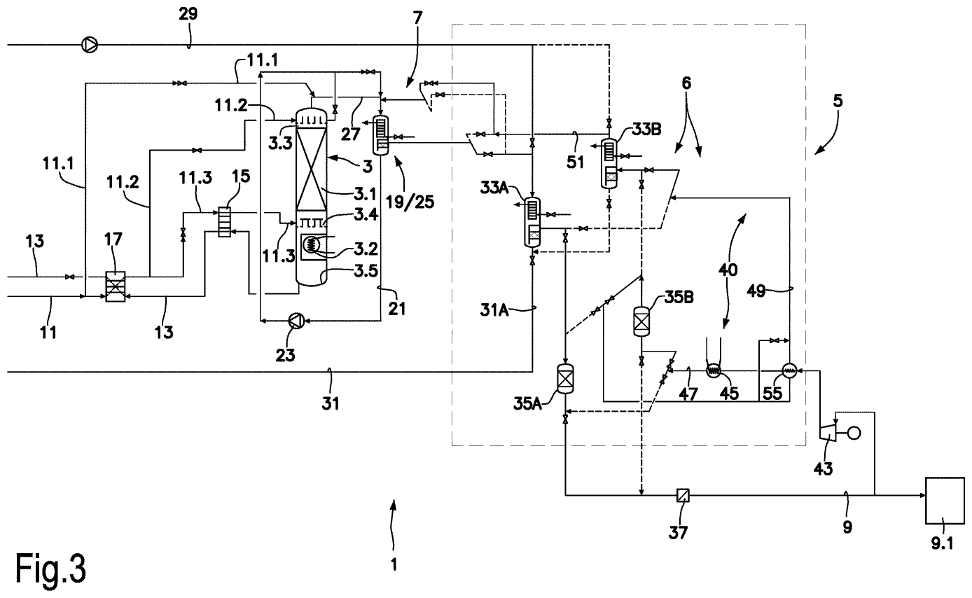

A further embodiment of a system according to the present disclosure is shown in FIG. 3. The same reference numbers are used to indicate elements corresponding to those already described in connection with FIGS. 1 and 2. These elements will not be described again.

The structure and operation of the system 1 of FIG. 3 are similar to the structure and operation of the system of FIGS. 1 and 2. The main difference between the embodiment of FIG. 3 and the embodiment of FIGS. 1 and 2 is that the overhead condenser 19 and the carbon dioxide cooler 25 of FIGS. 1 and 2 are replaced by a single condenser/cooler 19/25 shown outside the regenerator column 3 in FIG. 3 and which belongs to the regenerator cooling system 7 upstream of the carbon dioxide chilling and drying arrangement 6. Similarly to the system of FIGS. 1 and 2, in FIG. 3 a first cooling step of the CO₂-containing gaseous stream is performed in the regenerator cooling system 7. A first portion of moisture in the CO₂-containing gaseous stream is thus condensed in the condenser/cooler 19/25. The condensate contains ammonia and can be recycled through a recycling line 21 towards the top of the condenser/cooler 19/25 to flow therethrough.

The resulting cooled CO₂-containing gaseous stream is further processed in one of the first carbon dioxide chiller 33A and second carbon dioxide chiller 33B and subsequently dried in the respective first carbon dioxide dryer 35A or second carbon dioxide drier 35B, quite in the same manner as described above in connection with FIGS. 1 and 2. The other carbon dioxide chiller and carbon dioxide dryer which are not in service are in a regenerative phase through a side stream of compressed and heated dehydrated carbon dioxide recycled from the collecting line 9 through the carbon dioxide compressor 43.

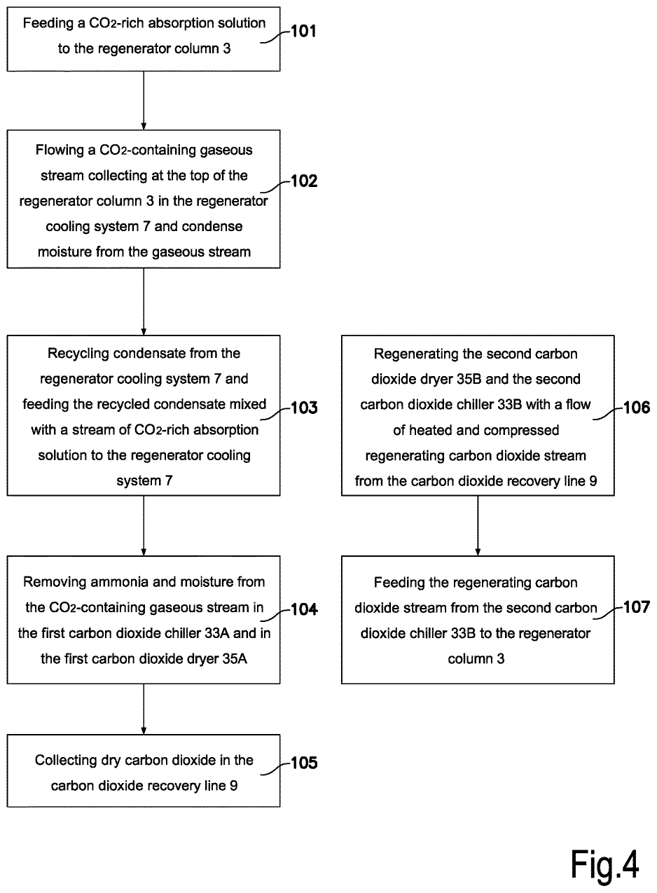

A schematic summary of a method for carbon dioxide recovery and conditioning according to the present disclosure is shown in FIG. 4. The method comprises the following steps: feeding a CO₂-rich absorption solution to the regenerator column 3 (step 101); flowing a CO₂-containing gaseous stream collecting at the top of the regenerator column 3 in the regenerator cooling system 7 and condense moisture from the gaseous flow (step 102); recycling condensate from the regenerator cooling system 7 and feeding the recycled condensate mixed with a stream of CO₂-rich absorption solution to the regenerator cooling system 7 (step 103); removing ammonia and moisture from the CO₂-containing gaseous stream in the first carbon dioxide chiller 33A and in the first carbon dioxide dryer 35A (step 104); and collecting dry carbon dioxide in the carbon dioxide recovery line 9 (step 105).

In parallel to the above steps, the method includes the additional following steps: regenerating the second carbon dioxide dryer 35B and the second carbon dioxide chiller 33B with a flow of heated and compressed regenerating carbon dioxide stream from the carbon dioxide recovery line 9 (step 106); and feeding the regenerating carbon dioxide stream from the second carbon dioxide chiller 33B to the regenerator column 3 (step 107).

Regenerating the second carbon dioxide dryer 35B and the second carbon dioxide chiller 33B with a flow of heated and compressed regenerating carbon dioxide stream from the carbon dioxide recovery line 9

Feeding the regenerating carbon dioxide stream from the second carbon dioxide chiller 33B to the regenerator column 3

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A carbon dioxide recovery and conditioning system for an ammonia-based carbon dioxide capture process, wherein the system comprises:
a regenerator column adapted to receive a CO₂-rich absorption solution from a rich absorption solution inlet line, the absorption solution including ammonia;
a regenerator cooling system adapted to cool a gaseous flow comprising carbon dioxide, ammonia and moisture, which collects at the top of the regenerator column; wherein the regenerator cooling system comprises a regenerator overhead condenser having a hot side and a cold side; wherein the hot side is adapted to receive a gaseous stream containing carbon dioxide moisture and ammonia from the regenerator column and the cold side is adapted to circulate a heat-recovery cooling medium therein; and
wherein the regenerator overhead condenser is adapted to condense and remove moisture and ammonia from the gaseous stream;
a carbon dioxide chilling and drying arrangement, fluidly coupled to the regenerator cooling system and to a carbon dioxide recovery line.

2. The system of claim 1, wherein the carbon dioxide chilling and drying arrangement comprises:
a first carbon dioxide chiller adapted to be fluidly coupled to an outlet of the regenerator cooling system;
a first carbon dioxide dryer fluidly coupled to an outlet of the first carbon dioxide chiller;
a second carbon dioxide chiller adapted to be fluidly coupled to the outlet of the regenerator cooling system;
a second carbon dioxide dryer fluidly coupled to an outlet of the second carbon dioxide chiller;
wherein the first carbon dioxide dryer and the second carbon dioxide dryer are fluidly coupled to a carbon dioxide recovery line; and
a dryer and chiller regenerative arrangement, adapted to regenerate selectively one of said first carbon dioxide dryer and second carbon dioxide dryer and one of said first carbon dioxide chiller and second carbon dioxide chiller while the other of said first carbon dioxide dryer and second carbon dioxide dryer and the other of said first carbon dioxide chiller and second carbon dioxide chiller are operating; wherein the dryer and chiller regenerative arrangement comprises a fluid coupling between the first carbon dioxide chiller and the regenerator cooling system, and between the second carbon dioxide chiller and the regenerator cooling system, adapted to return a flow of regenerating carbon dioxide from the carbon dioxide chiller being regenerated to the regenerator cooling system.

3. The system of claim 2, wherein the dryer and chiller regenerative arrangement comprises a carbon dioxide compressor and a heater, adapted to feed a stream of compressed dry carbon dioxide from the carbon dioxide recovery line through the one of said first carbon dioxide dryer and second carbon dioxide dryer and through the one of said first carbon dioxide chiller and second carbon dioxide chiller, which are selectively regenerated.

4. The system of claim 3, wherein the dryer and chiller regenerative arrangement comprises a recovery heat exchanger adapted to heat carbon dioxide from the carbon dioxide compressor in heat exchange with a regenerative carbon dioxide flow streaming from the carbon dioxide dryer to the carbon dioxide chiller which are selectively regenerated.

5. The system of claim 1, further comprising a CO₂-rich absorption solution feed fluidly coupled to the regenerator overhead condenser.

6. The system of claim 1, wherein the regenerator overhead condenser is arranged in the regenerator column.

7. The system of claim 1, wherein the regenerator overhead condenser is combined with a carbon dioxide cooler forming a combined condenser/cooler therewith.

8. The system of claim 1, wherein the regenerator cooling system further comprises a carbon dioxide cooler, having a hot side inlet fluidly coupled to an outlet of the hot side of the regenerator overhead condenser and a hot side outlet fluidly coupled to the carbon dioxide chilling and drying arrangement and adapted to circulate a gaseous flow containing carbon dioxide in heat exchange with a flow of cooling medium flowing in a cold side of the carbon dioxide cooler; wherein the carbon dioxide cooler is further coupled to a water wash line adapted to feed wash water to the cooler to remove ammonia salts which may form on the carbon dioxide cooler.

9. The system of claim 8, further comprising a wash water supply line, fluidly coupled to the carbon dioxide cooler and adapted to distribute wash water therein.

10. The system of claim 1, further comprising a recycling line adapted to recycle liquid condensed in the regenerator overhead condenser to an upper section of the regenerator overhead condenser in counterflow with the gaseous stream flowing through the regenerator overhead condenser.

11. The system of claim 1, further comprising a wash water supply line, fluidly coupled to the first carbon dioxide chiller and to the second carbon dioxide chiller.

12. The system of claim 11, wherein the wash water supply line is adapted to distribute wash water in the first carbon dioxide chiller and second carbon dioxide chiller during operation thereof.

13. A method for recovering and conditioning carbon dioxide from an ammonia-containing solvent, the method comprising the following steps:
processing a CO₂-rich absorption solution in a regenerator column and collecting a gaseous flow containing carbon dioxide, ammonia and moisture therefrom;
reducing the temperature of the gaseous flow and removing moisture and ammonia therefrom in a regenerator cooling system, by streaming the gaseous flow through an overhead condenser of the regenerator column in heat exchange with a cooling medium flowing in a cold side of the overhead condenser, thus causing condensation of moisture and ammonia;
further chilling the gaseous flow in a carbon dioxide chiller and removing further moisture and ammonia therefrom in a carbon dioxide chiller;
drying the gaseous flow in a carbon dioxide dryer; and
collecting dry carbon dioxide downstream of the carbon dioxide dryer.

14. The method of claim 13, further comprising the step of regenerating the carbon dioxide dryer and the carbon dioxide chiller with a stream of regenerating dry carbon dioxide.

15. The method of claim 14, further comprising the steps of compressing and heating the regenerating dry carbon dioxide upstream of the carbon dioxide dryer.

16. The method of claim 14, further comprising the step of streaming the regenerating carbon dioxide through the carbon dioxide dryer and the carbon dioxide chiller in series and further recycling the regenerating carbon dioxide from the carbon dioxide chiller towards the regenerator column.

17. The method of claim 14, wherein the carbon dioxide chiller comprises a first carbon dioxide chiller and a second carbon dioxide chiller; wherein the carbon dioxide dryer comprises a first carbon dioxide dryer and a second carbon dioxide dryer; and wherein the step of step of regenerating the carbon dioxide dryer and the carbon dioxide chiller with the stream of regenerating dry carbon dioxide comprises the step of regenerating one of said first carbon dioxide dryer and second carbon dioxide dryer and one of said first carbon dioxide chiller and second carbon dioxide chiller, while the other of said first carbon dioxide chiller and second carbon dioxide chiller and the other of said first carbon dioxide dryer and second carbon dioxide drier are in service.

18. The method of claim 13, further comprising the step of recovering heat from the cooling medium flowing through the overhead condenser.

19. The method of claim 13, further comprising the step of collecting condensate from the regenerator cooling system and recycling a portion of the condensate through the regenerator cooling system.

20. The method of claim 19, further comprising the step of collecting condensate from a bottom of the overhead condenser and recycle the condensate to a top of the overhead condenser.

21. The method of claim 19, comprising the step of mixing the recycled condensate with CO₂-rich absorption solution fed to the regenerator column.

22. The method of claim 13, further comprising the step of feeding a side stream of CO₂-rich absorption solution, delivered to the overhead condenser, to prevent precipitation of ammonia salts.

23. The method of claim 13, further comprising the step of streaming the gaseous flow from the overhead condenser through a carbon dioxide cooler, positioned upstream of the carbon dioxide chiller and receiving a wash water solution to avoid precipitation.

24. The method of claim 23, further comprising the step of feeding wash water to the carbon dioxide cooler.
